(19) United States
(12) Patent Application Publication
(10) Pub. No.: US 2022/0317052 A1
(43) Pub. Date: Oct. 6, 2022

(54) DETECTING DEVICE

(71) Applicant: InnoLux Corporation, Miao-Li County (TW)

(72) Inventor: Takanobu NAKAGAWA, Miao-Li County (TW)

(21) Appl. No.: 17/221,486

(22) Filed: Apr. 2, 2021

(51) Int. Cl. G01N 21/88; G01N 21/892

(52) U.S. Cl. CPC G01N 21/8806; G01N 21/892; G01N 21/8851; G01N 2021/8809; G01N 2021/8887

(57) ABSTRACT

A detecting device is provided; which includes: a substrate; a plurality of photo sensors disposed on the substrate; and a stress luminescent layer disposed on at least one of the plurality of photo sensors.

### BACKGROUND

### 1. Field

The present disclosure relates to a detecting device. More specifically, the present disclosure relates to a detecting device including a stress luminescent layer, a detection method using the same, and an input equipment including the detecting device.

### 2. Description of Related Art

The buildings or the infrastructures such as bridges or tunnels are degraded year by year. In order to ensure the safety of the buildings or the infrastructures, a monitor device (for example, cameras) may be used to detect the deterioration (such as cracks) of the buildings or the infrastructures. However, it is difficult to know when or where the deterioration of the buildings or the infrastructures occurred by using the currently developed monitor device.

Therefore, it is desirable to provide a novel detecting device.

### SUMMARY

The present disclosure provides a detecting device, including: a substrate, a plurality of photo sensors disposed on the substrate, and a stress luminescent layer disposed on at least one of the plurality of photo sensors.

The present disclosure further provides an input equipment, including the aforesaid detecting device and an object for writing or drawing on the surface of the detecting device.

The present disclosure further provides a detecting system, including the aforesaid detecting device, a control board, a power supply and a display device, wherein the power supply is a power source of the detecting system, a detection data obtained by the detecting device is transferred to the display device, and the control board is electrically connected to the display device.

The present disclosure also provides a detection method, including the following steps: providing the aforesaid detecting device or the aforesaid input equipment; and applying a stress on a position of the stress luminescent layer of the detecting device or the input equipment, wherein a stress luminescent material included in the stress luminescent layer emits light at the position of the stress luminescent layer, and the light is detected by at least one of the plurality of photo sensors corresponding to the position of the stress luminescent layer.

Other novel features of the disclosure will become more apparent from the following detailed description when taken in conjunction with the accompanying drawings.

### BRIEF DESCRIPTION OF THE DRAWINGS

FIG. 1 is a schematic diagram of a detecting system according to one embodiment of the present disclosure.

FIG. 2 is a schematic top view of a detecting device according to one embodiment of the present disclosure.

FIG. 3 is a schematic cross-sectional view of a detecting device according to one embodiment of the present disclosure.

FIG. 4 is a circuit diagram for a photo sensor in a detecting device according to one embodiment of the present disclosure.

FIG. 5 is a circuit diagram fir a photo sensor connecting to a charge amplifier via a data line in a detecting device according to one embodiment of the present disclosure.

FIG. 6 is a circuit diagram for a photo sensor connecting to a charge amplifier in a detecting device according to another embodiment of the present disclosure.

FIG. 7 is a schematic cross-sectional view of a detecting device according to another embodiment of the present disclosure.

FIG. 8 is a schematic cross-sectional view of a detecting device according to further another embodiment of the present disclosure.

FIG. 9 is a schematic diagram showing a detecting device is applied onto a building or an infrastructure according to one embodiment of the present disclosure.

FIG. 10 is a schematic diagram of an input equipment according to one embodiment of the present disclosure.

### DETAILED DESCRIPTION OF EMBODIMENT

Different embodiments of the present disclosure are provided in the following description. These embodiments are meant to explain the technical content of the present disclosure, but not meant to limit the scope of the present disclosure. A feature described in an embodiment may be applied to other embodiments by suitable modification, substitution, combination, or separation.

It should be noted that, in the present specification, when a component is described to “comprise”, “have”, “include” an element, it means that the component may include one or more of the elements, and the component may include other elements at the same time, and it does not mean that the component has only one of the element, except otherwise specified.

Moreover, in the present specification, the ordinal numbers such as “first” or “second”, are only used to distinguish a plurality of elements having the same name, and it does not means that there is essentially a level, a rank, an executing order, or an manufacturing order among the elements, except otherwise specified. The ordinal numbers of the elements in the specification may not be the same in claims. For example, a “second” element in the specification may be a “first” element in the claims.

In the present specification, except otherwise specified, the feature A “or” or “and/or” the feature B means only the existence of the feature A, only the existence of the feature B, or the existence of both the features A and B. The feature A “and” the feature B means the existence of both the features A and B.

Moreover, in the present specification, the terms, such as “top”, “upper”, “bottom”, “front”, “back” or “middle”, as well as the terms, such as “on”, “above”, “over”, “under”, “below” or “between”, are used to describe the relative positions among a plurality of elements, and the described relative positions may be interpreted to include their translation, rotation, or reflection.

Furthermore, the terms recited in the specification and the claims such as “above”, “over”, “on”, “below”, or “under” are intended that an element may not only directly contacts other element, but also indirectly contact the other element.

Furthermore, the term recited in the specification and the claims such as “connect” is intended that an element may not only directly connect to other element, but also indirectly connect to other element. On the other hand, the terms recited in the specification and the claims such as “electrically connect” and “couple” are intended that an element may not only directly electrically connect to other element, but also indirectly electrically connect to other element.

In the present specification, except otherwise specified, the terms (including technical and scientific terms) used herein have the meanings generally known by a person skilled in the art. It should be noted that, except otherwise specified in the embodiments of the present disclosure, these terms (for example, the terms defined in the generally used dictionary) should have the meanings identical to those skilled in the art, the background of the present disclosure or the context of the present specification, and should not be read by an ideal or over-formal way.

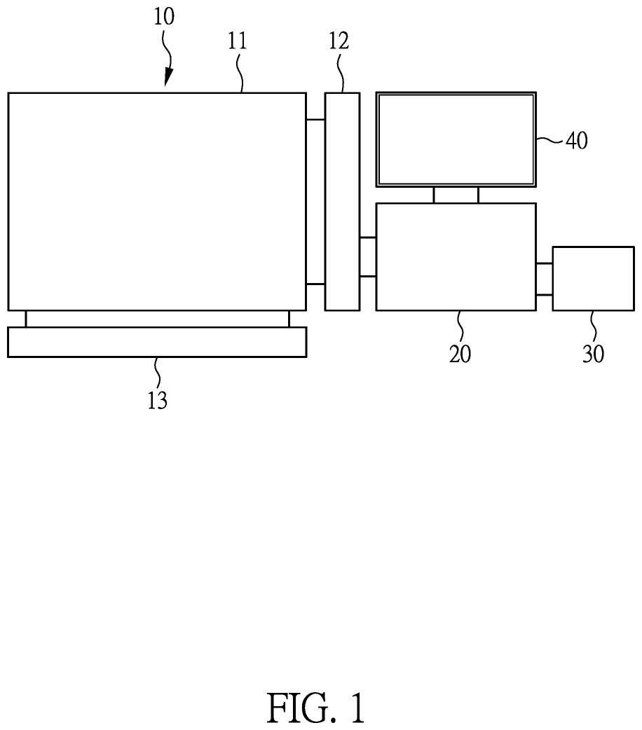

FIG. 1 is a schematic diagram of a detecting system according to one embodiment of the present disclosure. In the present embodiment, the detecting system may include: a detecting device 10, a control board 20, a power supply 30 and a display device 40. Herein, the power supply 30 is electrically connected to the control board 20, and the control board 20 is electrically connected to the detecting device 10 and the display device 40. The power supply 30 can be a power source of the detecting system. The detection data obtained by the detecting device 10 can be transferred to the display device 40, and the user can check the detection result from the display device 40. In FIG. 1, the control board 20 may be electrically connected to the display device 40 via a wired manner, but the present disclosure is not limited thereto. In another embodiment of the present disclosure, the control board 20 can be connected to the display device 40 via a wireless manner. Furthermore, in FIG. 1, the detecting system includes the control board 20 for setting or controlling the detection of the detecting device 10, but the present disclosure is not limited thereto. In another embodiment of the present disclosure, the control board 20 may be integrated with the detecting device 10 or the display device 40.

The detecting device 10 may include: a substrate 11; a first circuit board 12 connecting to the substrate 11; and a second circuit board 13 connecting to the substrate 11. Herein, a plurality of wirings and transistors (not shown in the figure) may be formed on the substrate 11, circuits on the first circuit board 12 and circuits on the second circuit board 13 are respectively electrically connected to the wirings and transistors on the substrate 11 to provide signals to the transistors or to receive signals from the transistors. In the present embodiment, the first circuit board 12 and the second circuit board 13 may be connected to two sides of the substrate 11, but the present disclosure is not limited thereto. The dispositions of the first circuit board 12 and the second circuit board 13 may be modified according to the need. Hereinafter, the structures of the elements on the substrate 11 are illustrated below.

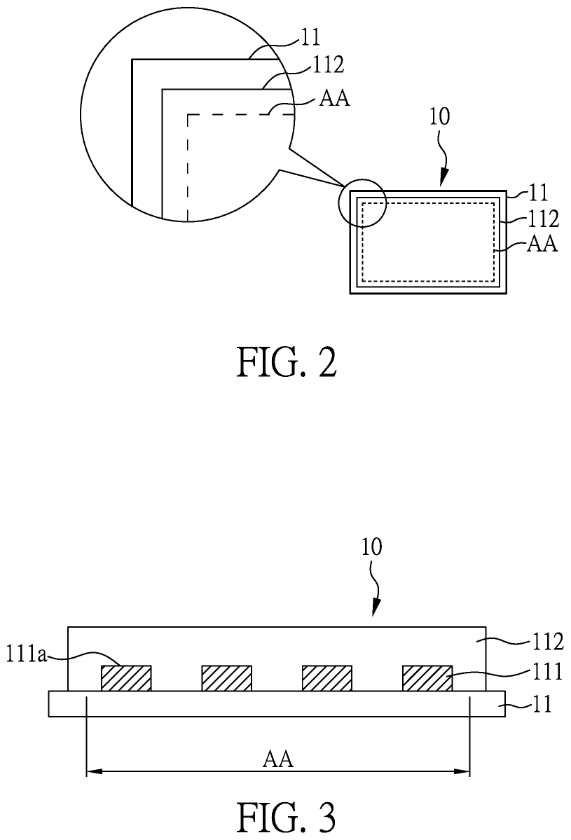

Please refer to FIG. 2 and FIG. 3. FIG. 2 is a schematic top view of a detecting device according to one embodiment of the present disclosure, and FIG. 3 is a schematic cross-sectional view of a detecting device according to one embodiment of the present disclosure. The detecting device of the present embodiment includes: a substrate 11; a plurality of photo sensors 111 disposed on the substrate 11; and a stress luminescent layer 112 disposed on at least one of the plurality of photo sensors 111. Herein, all the photo sensors 111 are covered by the stress luminescent layer 112, but the present disclosure is not limited thereto.

It should be noted that the stress luminescent material is one kind of the luminescent materials that can emit light when receiving mechanical stresses.

In principle, the electronic state of the stress luminescent material can be excited by UV radiation, electron beams (EBs), X-rays, electric fields, etc. When mechanical stresses are applied onto the stress luminescent material, the stress luminescent material can release the stress in a form of light.

In the present embodiment, the substrate 11 may be a non-flexible substrate or a flexible substrate. The material of the substrate 11 may include glass, quartz, silicon wafer, sapphire, polycarbonate (PC), polyimide (PI), polypropylene (PP), polyethylene terephthalate polyethylene naphthaiate (PEN), other suitable material, or a combination thereof.

The stress luminescent layer 112 includes a stress luminescent material which can emit light by mechanical stresses. Examples of the stress luminescent material in the stress luminescent layer 112 may include SrAl₂O₄:Eu, ZnS:Mn, (Ba,Ca)TiO₃:Pr, CaYAl₃O₇:Ce or a combination thereof, but the present disclosure is not limited thereto.

The photo sensors 111 may be photo diodes or photo transistors. In one embodiment of the present disclosure, the photo sensors 111 are photo diodes, but the present disclosure is not limited thereto.

In one embodiment of the present disclosure, the stress luminescent material included in the stress luminescent layer 112 is SrAl₂O₄:Eu, which can emit green light by mechanical stresses. In this case, the photo diodes may be silicon-based photo diodes (such as a-Si PIN diodes), because the light absorption wavelengths of the silicon-based photo diodes can match the wavelengths of the light emitting from SrAl₂O₄:Eu. However, the present disclosure is not limited thereto. In other words, the light absorption wavelengths of the photo diodes should match the light emitting wavelengths of the stress luminescent material.

In addition, the detecting device of the present embodiment further includes an active region AA, and the active region AA is a region that the photo sensors 111 and transistors (not shown in the figure) are disposed therein. In the top view, the area of the stress luminescent layer 1.12 may be greater than the area of the active region AA, More specifically, the entire active region AA may be covered by the stress luminescent layer 112, and the photo sensors 111 and transistors are covered by the stress luminescent layer 112.

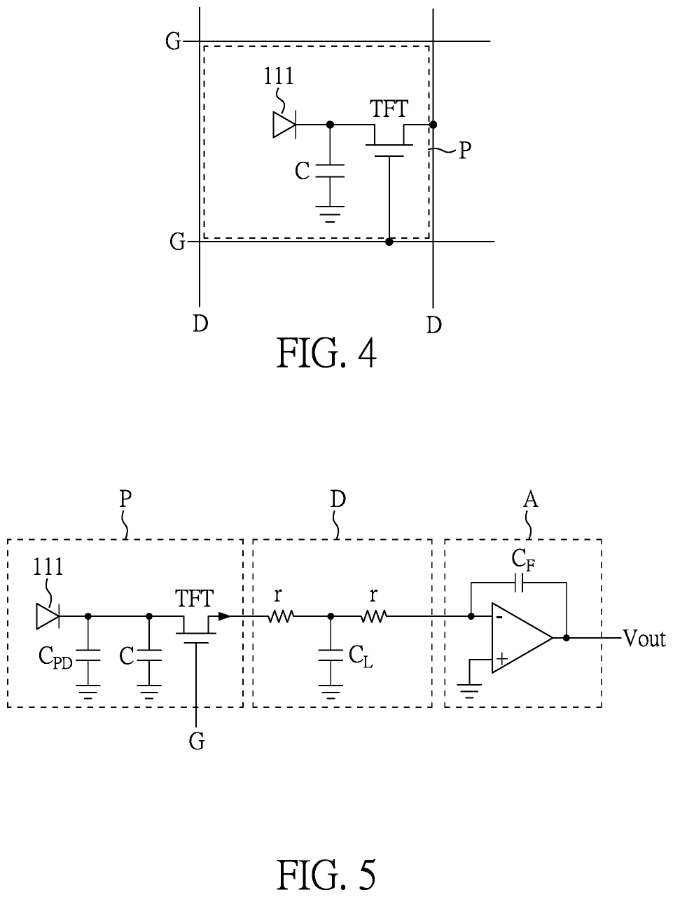

FIG. 4 is a circuit diagram for a photo sensor in a detecting device according to one embodiment of the present disclosure. Herein, the circuit diagram for one photo sensor 111 in FIG. 3 is shown in FIG. 4, and the circuit diagrams for other photo sensors 111 are similar to that shown in FIG. 4 and are not repeatedly described. It should be noted that the circuit diagram in FIG. 4 is only an example, and the design of the circuit diagram is not limited thereto.

In the present embodiment, the detecting device may include a plurality of transistors TFT disposed on the substrate 11 (as shown in FIG. 2), wherein at least one of the plurality of transistors TFT is electrically connected to the photo sensor 111. Herein, one transistor TFT may be electrically connected to one photo sensor 111. A gate line G is electrically connected to the transistor TFT. A data line D is also electrically connected to the transistor TFT.

The detecting device of the present embodiment may further include at least one capacitor C electrically connected to the photo sensor 111, Herein, one capacitor C is electrically connected to one photo sensor 111. In addition, the capacitor C is further electrically connected to the transistor TFT. In another embodiment of the present disclosure, the detecting device may not include the capacitor C if the junction capacitance of the photo sensor 111 is large enough. For example, when the junction capacitance of the photo sensor 111 is 100 times the capacitor C which is usually used for a photo sensor, the capacitor C may be excluded.

In addition, the detecting device of the present embodiment may include a plurality of pixels P, and the block shown in FIG. 4 represents one of the pixels P of the detecting device. The pixels P may be arranged in an array and be at least a part of a large-area two-dimensional detecting device. As shown in FIG. 4, one pixel P of the detecting device of the present embodiment may be in a space defined by two adjacent gate lines G and two adjacent data lines D, and one photo sensor 111, one transistor T and one capacitor C is included in one pixel P.

Herein, the circuit diagram shown in FIG. 4 is based on the passive pixel sensor (PPS) architecture, which is one kind of the architecture for the stress emissive light detection and provides the compact pixel design for high resolution, but the disclosure is not limited thereto. In some embodiments of the present disclosure, the active pixel sensor (APS) architecture can be used.

FIG. 5 is a circuit diagram for a photo sensor connecting to a charge amplifier via a data line in a detecting device according to one embodiment of the present disclosure. The left block of FIG. 5 shows the equivalent circuit of the pixel P which is similar to that shown in FIG. 4, except that the junction capacitance C_{pD} of the photo sensor 111 is further included in FIG. 5. The middle block of FIG. 5 shows the equivalent circuit with equivalent resists r and equivalent capacitor C_{L} of the data line D shown in FIG. 4. The number of middle blocks is similar to or equal to the number of the pixels. The right block of in FIG. 5 shows the equivalent circuit of the charge amplifier A electrically connecting to the photo sensor 111, and the right block is used to catch the signals from the pixels P, As shown in FIG. 5, the photo sensor 111 is electrically connected to the charge amplifier A via the data line D.

The detection using the PPS architecture shown in FIG. 4 and FIG. 5 includes two steps. The first step is integration and the second step is readout and reset. In the first step, the transistor TFT is OFF, and the electric charge is generated in the photo sensor 111. The electric charge is converted from the light emitting from the stress luminescent material and then stored in the pixel capacitor (including the capacitor C and the junction capacitance C_{PD}). In the second step, the transistor TFT is ON, and the stored electric charge in the pixel capacitor (including the capacitor C and the junction capacitance C_{PD}) is transferred to the charge amplifier A via the data line D and converted to an equivalent voltage Vout. After the electric charge is read out, the electric charge in the pixel capacitor (including the capacitor C and the junction capacitance C_{PD}) is reset to substantially zero, and the pixel P is ready for the next integration,

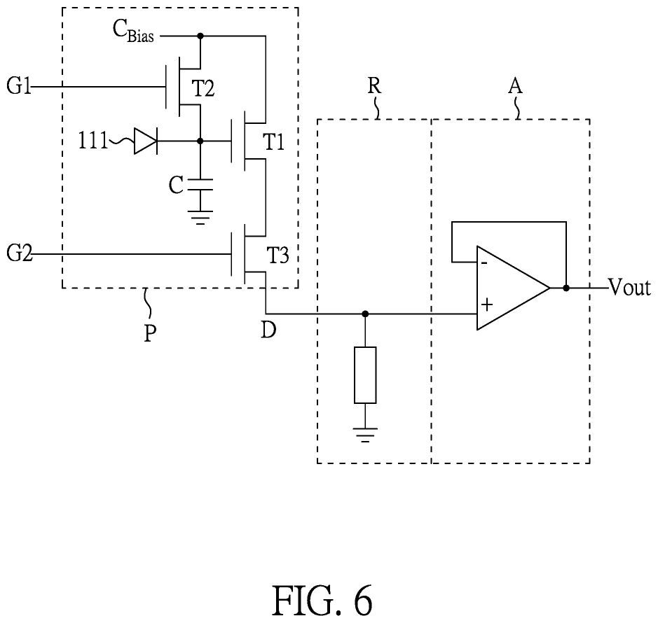

FIG. 6 is a circuit diagram of a photo sensor connecting to a charge amplifier in a detecting device according to another embodiment of the present disclosure. Herein, the circuit diagram for one photo sensor 111 in FIG. 3 is shown in FIG. 6, and the circuit diagrams for other photo sensors 111 are similar to that shown in FIG. 6 and are not repeatedly described.

In the present embodiment, the detecting device may further include a plurality of transistors (including a first transistor T1, a second transistor T2 and a third transistor T3) disposed on the substrate 11 (as shown in FIG. 2), wherein the plurality of transistors (including the first transistor T1, the second transistor 12 and the third transistor T3) may be electrically connected to the photo sensor 111. Herein, the first transistor T1 is electrically connected to the photo sensor 111, the second transistor T2 and the third transistor 13. The second transistor 12 is electrically connected to a first gate line G1, the photo sensor 111 and the first transistor T1. The third transistor 13 is electrically connected to a second gate line G2, the first transistor T1 and a data line D.

The detecting device of the present embodiment may further include at least one capacitor C electrically connected to the photo sensor 111. Herein, one capacitor C is electrically connected to one photo sensor 111. In addition, the capacitor C is further electrically connected to the first transistor T1 and the second transistor T2. In another embodiment of the present disclosure, the detecting device may not include the capacitor C if the junction capacitance of the photo sensor 111 is large enough.

In addition, the detecting device of the present embodiment may include a plurality of pixels, and the left block of FIG. 6 represents the circuit of one of the pixels P of the detecting device. The pixels P may be arranged in an array to achieve the purpose of large-area two-dimensional detection. As shown in FIG. 6, one pixel P of the detecting device of the present embodiment may be defined by the first gate line G1, the second gate line G2 and data lines D. One photo sensor 1.11 three transistors (including the first transistor T1, the second transistor T2 and the third transistor T3) and one capacitor C is included in one pixel P.

Herein, the circuit diagram shown in FIG. 6 is based on the active pixel sensor (APS) architecture. The APS architecture shown in FIG. 6 may reduce noise or increase readout speed because the detection result of the photo sensor 111 in the APS architecture is converted to an equivalent voltage or current.

In FIG. 6, the middle block shows the circuit of a high resistance column load. R, and the right block shows the circuit of a charge amplifier A connecting to the photo sensor 111.

The detection using the APS architecture shown in FIG. 6 includes three steps. The first step is reset, the second step is integration and the third step is readout. In the first step, the second transistor T2 is used as a switch to reset the photo sensor 111 to a preset voltage prior to integration. In the second step, the electric charge generated in the photo sensor 111 converted from the light emitting from the stress luminescent material is stored into the pixel capacitor (including the capacitor C and the junction capacitance of the photo sensor 111), modulating its preset voltage. In the third step, the third transistor T3 is switched ON and the voltage of the photo sensor 111 is buffered out by the first transistor T1, and transferred to the charge amplifier A.

Herein, even not shown in FIG. 6, the equivalent circuit of the data line D shown in FIG. 5 may be electrically connected between the pixel P and the charge amplifier A. In addition, the circuit diagram shown in FIG. 6 further includes a high resistance column load R, but the detecting device may not include the high resistance column load R in another embodiment of the present disclosure. Furthermore, the high resistance column load shown in FIG. 6 may also be applied to the PPS architecture shown in FIG. 5 and located between the data line D and the charge amplifier A in further another embodiment of the present disclosure.

The detecting device illustrated above can be applied in a detection method. First, the detecting device 10 shown in FIG. 1 to FIG. 3 is provided. When a stress is applied onto a position of the stress luminescent layer 112 of the detecting device 10, the stress luminescent material included in the stress luminescent layer 112 emits light at the position, and the light is detected by at least one of the plurality of photo sensors 111 corresponding to the position.

More specifically, as shown in FIG.1 to FIG. 3, when a stress is applied onto a position of the stress luminescent layer 112 of the detecting device 10, the stress luminescent material included in the stress luminescent layer 112 and corresponding to the position can emit light. Then, one or more the photo sensors 111 corresponding to the position can receive the light emitting from the stress luminescent material and convert the light into electric charge. As shown in FIG. 4 to FIG. 6, in the PPS architecture or the APS architecture, the converted electric charge can be stored in the pixel capacitor (including the capacitor C and the junction capacitance of the photo sensor 111). By scanning the pixels P on the substrate 11, the stored electric charge can be read out via the transistor (fir example, the transistor TFT in the PPS architecture, or the first transistor TFT1, the second transistor TFT2 and the third transistor TFT3 in the APS architecture), and then the position that the stress is applied can be identified. Furthermore, according to the amount of the stored electric charge, the intensity of the stress applied may also be identified.

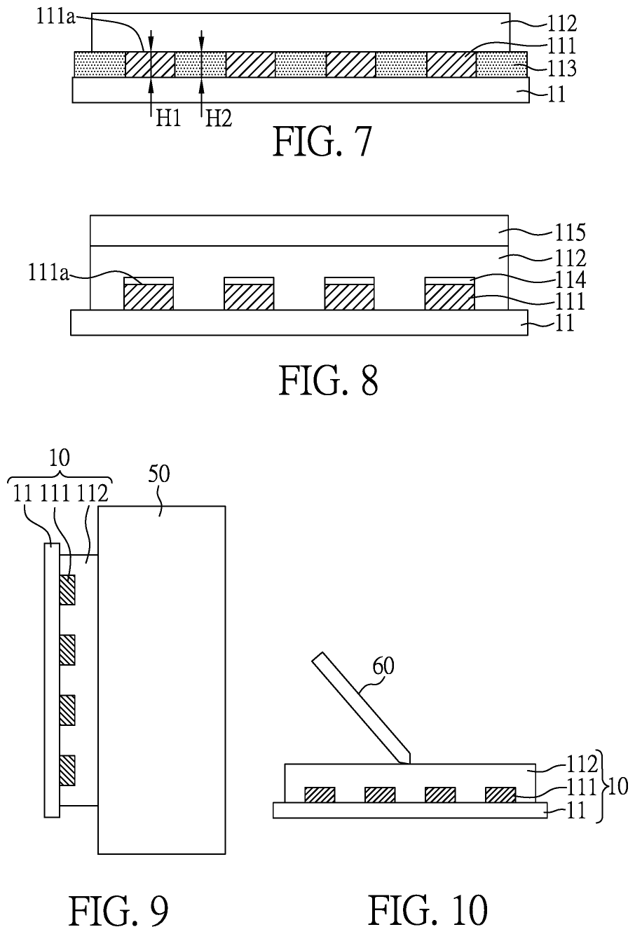

FIG. 7 is a schematic cross-sectional view of a detecting device according to another embodiment of the present disclosure. The detecting device of the present embodiment is similar to that shown in FIG. 3, except for the following differences.

As shown in FIG. 7, the detecting device of the present embodiment may further include a partition layer 113 disposed on the substrate 11, wherein a part of the partition layer 113 is disposed between two adjacent ones of the plurality of photo sensors 111. When the partition layer 113 is disposed between two adjacent photo sensors ill, the detection accuracy of the detecting device may further be improved because the cross talk occurred between two adjacent photo sensors 111 can be reduced.

Herein, the material of the partition layer 113 is not particularly limited, and can be any material which is capable of reducing the cross talk occurred between the photo sensors 111. For example, the partition layer 113 may be a black matrix layer, but the present disclosure is not limited thereto.

In the present embodiment, the height H1 of the partition layer 113 is substantially equal to the height H2 of the photo sensors M. In some embodiments of the present disclosure, the height H1 of the partition layer 113 may be greater than the height H2 of the photo sensors 111. It should be noted that the height H1 of the partition layer 113 may be the greatest distance from the bottom surface of the partition layer 113 to the top surface of the partition layer 113, and it may be measured in the normal direction of the substrate 11, and the height H2 of the photo sensor 111 may be the greatest distance from the bottom surface of the photo sensor 111 to the top surface of the photo sensor 111, and it may be measured in the normal direction of the substrate 11 too.

FIG. 8 is a schematic cross-sectional view of a detecting device according to further another embodiment of the present disclosure. The detecting device of the present embodiment is similar to that shown in FIG. 3, except for the following differences.

As shown in FIG. 8, the detecting device of the present embodiment may further include a light transmissible layer 114 disposed on at least one of the photo sensors 111. In the present embodiment, the light transmissible layer 114 is disposed between the surfaces 111a of all the photo sensors 1111 and the stress luminescent layer 112, In another embodiment of the present disclosure, the light transmissible layer 114 may be formed on a portion of the photo sensors 111. Herein, the light transmissible layer 114 includes a light transmissible material which has a certain transmittance at the wavelengths corresponding to the light emitting from the stress luminescent material of the stress luminescent layer 112. The light transmissible layer 114 may be used as a protection layer for protecting the photo sensors 11 from being damaged, or used as a buffer layer for improving the adhesion between the photo sensors 11 and the stress luminescent layer 112.

In addition, the detecting device of the present embodiment may further include a protection layer 115 disposed on the stress luminescent layer 112, The material of the protection layer 115 may include an insulating material. The protection layer 115 may be used as a protection layer for protecting the stress luminescent layer 112 from moisture intrusion, or used as an adhesion layer for attaching the detecting device onto other targets, such as a building or an infrastructure.

In another embodiment of the present disclosure, the stress luminescent layer 112 may be patterned, as long as the stress luminescent layer 112 overlaps the sensing regions of the photo sensors 11. For example, the stress luminescent layer 112 is only formed on the surfaces 111a of the photo sensors 11, but the region outside the photo sensors 11 is not covered by the stress luminescent layer 112.

FIG. 9 is a schematic diagram showing a detecting device is applied onto a building or an infrastructure according to one embodiment of the present disclosure.

As shown in FIG. 9, the detecting device 10 can be assembled on a building or an infrastructure 50, and especially on the wall of the building or the infrastructure 50. When the detecting device 10 is attached onto the building or the infrastructure 50, the deterioration of the building or the infrastructure 50 can be detected. For example, when a crack is formed, the stress released by the crack can be applied onto the stress luminescent layer 112, and the light emitting from the stress luminescent material included in the stress luminescent layer 112 can be detected by the photo sensors 111 according to the detection method illustrated above. Thus, the position of the crack or the timing that the crack occurred can be identified.

In another embodiment of the present disclosure, a protection layer or an adhesion layer may be formed between the detecting device 10 and the wall of the building or the infrastructure 50 to improve the adhesion or the reliability of the detecting device 10 on the building or the infrastructure 50.

Herein, the detecting device 10 shown in FIG. 3 may be used as an example of the present disclosure, but the present disclosure is not limited thereto. Any of the aforesaid detecting devices of the present disclosure can be attached onto the building or the infrastructure 50.

FIG. 10 is a schematic diagram of an input equipment according to one embodiment of the present disclosure.

As shown in FIG. 10, the input equipment may include the detecting device 10 shown in FIG. 3. Similarly, the present disclosure is not limited thereto, and any of the aforesaid detecting devices of the present disclosure can be used as the input equipment. In addition, the input equipment may further include an object 60 (such as a pen or a finger) for writing or drawing on the surface of the detecting device 10. When a user writes words or draws pictures on the surface of the detecting device 10, the stress luminescent material located at the corresponding trajectory can emit light, and the light can be detected by the corresponding photo diodes 111 and then be memorized or processed.

In the present disclosure, the features in different embodiments of the present disclosure can be mixed to form another embodiment without departing from the spirit and scope of the disclosure as hereinafter claimed.

Although the present disclosure has been explained in relation to its embodiment, it is to be understood that many other possible combinations, modifications and variations can be made without departing from the spirit and scope of the disclosure as hereinafter claimed,

What is claimed is:

1. A detecting device, comprising:
a substrate;
a plurality of photo sensors disposed on the substrate; and
a stress luminescent layer disposed on at least one of the plurality of photo sensors.

2. The detecting device of claim 1, further comprising a partition layer disposed on the substrate, wherein a part of the partition layer is disposed between two adjacent ones of the plurality of photo sensors.

3. The detecting device of claim 2, wherein the partition layer is a black matrix layer.

4. The detecting device of claim 2, wherein a height of the partition layer is equal to a height of the plurality of photo sensors.

5. The detecting device of claim 2, wherein a height of the partition layer is greater than a height of the plurality of photo sensors.

6. The detecting device of claim 1, wherein the plurality of photo sensors are photo diodes or photo transistors

7. The detecting device of claim 1, further comprising at least one capacitor electrically connected to the at least one of the plurality of photo sensors.

8. The detecting device of claim 1, wherein the substrate comprises an active region, and an area of the stress luminescent layer is greater than an area of the active region in a top view.

9. The detecting device of claim 1, further comprising a plurality of transistors disposed on the substrate, wherein at least one of the plurality of transistors is electrically connected to the at least one of the plurality of photo sensors.

10. The detecting device of claim 9, wherein the at least one of the plurality of photo sensors is disposed in a pixel.

11. The detecting device of claim 1, further comprising at least one charge amplifier, wherein the at least one of the plurality of photo sensors electrically connects to the at least one charge amplifier via a data line.

12. The detecting device of claim 1, wherein the stress luminescent layer comprises SrAl₂O₄:Eu, ZnS:Mn, (Ba, Ca)TiO₃:Pr, CaYAl₁O₇:Ce or a combination thereof.

13. The detecting device of claim 1, further comprising a protection layer disposed on the stress luminescent layer.

14. The detecting device of claim 13, wherein the protection layer is an adhesion layer.

15. The detecting device of claim 1, wherein the stress luminescent layer is patterned.

16. The detecting device of claim 15, wherein a region outside the plurality of photo sensors is not covered by the stress luminescent layer.

17. The detecting device of claim 1, further comprising a light transmissible layer disposed between the plurality of photo sensors and the stress luminescent layer.

18. The detecting device of claim 1, wherein the detecting device is attached onto a building or an infrastructure.

19. An input equipment, comprising:
a detecting device, comprising:
a substrate;
a plurality of photo sensors disposed on the substrate; and
a stress luminescent layer disposed on at least one of the plurality of photo sensors; and
an object configured for writing or drawing on a surface of the detecting device.

20. A detecting system, comprising:
a detecting device, comprising:
a substrate;
a plurality of photo sensors disposed on the substrate; and
a stress luminescent layer disposed on at least one of the plurality of photo sensors;
a control board;
a power supply; and
a display device,
wherein the power supply is a power source of the detecting system, a detection data obtained by the detecting device is transferred to the display device, and the control board is electrically connected to the display device.
